(19) United States
(12) Patent Application Publication
(10) Pub. No.: US 2025/0257481 A1
(43) Pub. Date: Aug. 14, 2025

(54) POROUS TRANSPORT LAYERS HAVING COATED CATALYST COMPOSITIONS AND METHODS OF MAKING

(71) Applicant: ELECTRIC HYDROGEN CO., Devens, MA (US)

(72) Inventors: Ruofan Wang, Centennial, CO (US); Erin Brahm Creel, Framingham, MA (US); Timothy J. Kucharski, Belmont, MA (US)

(21) Appl. No.: 18/996,910

(22) PCT Filed: Aug. 12, 2024
(86) PCT No.: PCT/US2024/041878

§ 371 Date: Jan. 17, 2025

Related U.S. Application Data
(60) Provisional application No. 63/532,564, filed on Aug. 14, 2023.

(51) Int. Cl. C25B 11/031; C25B 1/04; C25B 9/23; C25B 11/063; C25B 11/081

(52) U.S. Cl. CPC C25B 11/031; C25B 1/04; C25B 9/23; C25B 11/063; C25B 11/081

(57) ABSTRACT

The following disclosure relates to electrochemical or electrolysis cells and components thereof. More specifically, the following disclosure relates to an improved porous transport layer (PTL) with catalyst coated particles or fibers, as well as methods of coating a PTL with a catalyst coating composition. In one example, a catalyst-ionomer mixture is coated onto Titanium (Ti) particles or fibers to form a percolated coating layer near a surface of the PTL via impregnation/infiltration, electrophoretic deposition, or electroplating.

This application claims the benefit of U.S. Provisional Patent Application No. 63/532,564, filed Aug. 14, 2023, which is hereby incorporated by reference in its entirety.

### FIELD

The following disclosure relates to electrochemical or electrolysis cells and components thereof. More specifically, the following disclosure relates to porous transport layers having coated catalyst compositions and methods of coating catalyst compositions onto such porous transport layers.

### BACKGROUND

Hydrogen has been considered as an ideal energy carrier to store renewable energy. Proton exchange membrane water electrolysis (PEMWE) as a means for hydrogen production offers high product purity, fast load response times, small footprints, high efficiencies, and low maintenance efforts. It is regarded as a promising technology, especially when coupled with renewable energy sources.

A PEMWE cell is a type of electrochemical cell that uses electricity to split water molecules into hydrogen and oxygen gas. The cell consists of two electrodes, an anode, and a cathode, separated by a proton exchange membrane (PEM). The anode is where water is oxidized to produce oxygen gas and protons, while the cathode is where hydrogen ions from the water are reduced to produce hydrogen gas.

For example, PEM electrolysis involves the use of a solid electrolyte or ion exchange membrane. Within the water splitting electrolysis reaction, one interface runs an oxygen evolution reaction (OER) while the other interface runs a hydrogen evolution reaction (HER). The anode reaction is H₂O→2H⁺+½O₂+2e⁻ and the cathode reaction is 2H⁺+2e^{-→H}₂. The water electrolysis reaction has recently assumed great importance and renewed attention as a potential foundation for a decarbonized “Hydrogen Economy.”

Various challenges are present with the operation at the PEM of an electrolysis cell. These challenges are not well described within the literature and are not fully appreciated in the field. For example, at the interface, a 4- or 5-fold junction is required at which a catalyst (e.g., IrOx catalyst) is supplied with water and electricity. Additionally, at the interface, protons and gas are needed to be removed. In other words, an electrolysis cell requires a 5-way interface between catalyst, water, electrical conductor, proton transport, and bubble formation/gas transport. However, this need for multiple interfaces is not fully appreciated in the literature and as a result the requirement is not well incorporated into existing state-of-the-art PEM systems. The current best-in-class commercial PEM electrolyzers do not have interfaces designed to optimize the transport and fluxes outlined above.

The central PEM/catalyst/water/gas interface is accomplished by randomly coating a catalyst and PEM material (ionomer) onto one or both of a PEM layer plus a PTL that permits liquids and gases to flow through the holes while the solid material conducts electricity. The PEM layer and the PTL are then joined with the hope that the desired multi-way junctions are present. This is especially problematic for the anode PTL. The anode side is traditionally the rate-limiting reaction, owing to slower catalyst kinetics and the requirement for larger overpotential. Moreover, because the anode PTL sits in an oxidizing acidic environment, it may be made of platinum-coated titanium. Titanium is a poor conductor, and the platinum is expensive.

In a PEM electrolyzer, iridium oxide is an example of a high performance catalyst used to promote the oxygen evolution reaction. Iridium is extremely rare and expensive. As such, the cost of electrolyzers is sensitive to the amount of iridium used. In addition, the scale of the PEM electrolyzer industry could become constrained by global iridium availability. Reducing the amount of iridium used may limit the operating lifetime of the electrolyzer as the catalyst has a tendency to degrade with use over time.

As such, there remains a need to develop an improved PTL composition to provide the possibility of extreme low catalyst loading on the anode side of the PEMWE cell without sacrificing cell performance and durability.

### SUMMARY

In one embodiment, a porous transport layer includes a base composition of particles or fibers arranged in a plurality of layers; and a catalyst coating composition that coats a portion of the particles or a portion of the fibers to a depth of the base composition as measured from a surface of the porous transport layer configured to be positioned adjacent to a membrane of an electrochemical cell.

In another embodiment, a method of coating a catalyst composition onto a base composition of a porous transport layer (PTL) is provided. The method includes: preparing a bath having a catalyst-ionomer mixture, the catalyst-ionomer mixture having a catalyst, an ionomer, and a solvent; submerging at least a portion of the base composition of the PTL into the bath of the catalyst-ionomer mixture, the base composition having a structure made up of particles or fibers; penetrating, by capillary force, the catalyst-ionomer mixture into the base composition of the PTL, such as to provide an impregnated composition; removing the impregnated composition from the bath; and drying the impregnated composition until the solvent in the catalyst-ionomer mixture has evaporated to provide a catalyst coated PTL composition in which the catalyst has coated the particles or the fibers of the base composition to a depth of the PTL.

In another embodiment, a method of coating a catalyst composition onto a base composition of a porous transport layer (PTL) via electrophoretic deposition is provided. The method includes: preparing a bath having a catalyst-ionomer solution, the catalyst-ionomer solution comprising iridium (Ir) nanoparticles with charged ligands, an ionomer having a same charge as the ligands, and an electrolyte; masking a first surface of the base composition of the PTL, the base composition comprising a structure made up of particles or fibers; submerging the PTL and an inert material into the bath, wherein the masked surface of the base composition functions as an anode and the inert material functions as a cathode for the electrophoretic deposition, and wherein a second, opposite surface of the base composition is facing the cathode; applying an electric field across the cathode and the anode such that the iridium nanoparticles in the catalyst-ionomer solution are deposited to a depth into the second surface of the base composition of the PTL; removing the PTL from the bath; and drying the PTL until the electrolyte in the catalyst-ionomer solution has evaporated to provide a catalyst coated PTL.

In another embodiment, a method of coating a catalyst composition onto a base composition of a porous transport layer (PTL) via electroplating is provided. The method includes: preparing a bath having a catalyst solution, the catalyst solution comprising iridium (Ir) salt and an electrolyte; masking a surface of the base composition of the PTL, wherein the base composition comprises a structure made up of particles or fibers; submerging the PTL and an inert material into the bath, wherein the masked surface of the base composition functions as an anode and the inert material functions as a cathode for the electroplating, and wherein a second, opposite surface of the base composition is facing the cathode; applying an electric potential to the cathode and the anode such that the iridium within the catalyst solution is deposited to a depth into the second surface of the base composition of the PTL; removing the PTL from the bath; drying the PTL until the electrolyte in the catalyst solution has evaporated to provide a catalyst coated PTL; and infiltrating an ionomer into the catalyst coated PTL such that the ionomer is mixed with the iridium to provide a catalyst-ionomer coating.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrochemical or electrolytic cell.

FIG. 2 depicts an additional example of various components of an electrochemical cell.

FIGS. 3a and 3b depict the surface morphology of two types of porous transport layer structures.

FIGS. 4a and 4b depict images of area-specific catalyst activity of conventional proton exchange membrane water electrolysis cells having two types of porous transport layer structures.

FIG. 5 depicts a conventional proton exchange membrane water electrolysis cell at an atomic scale (nanometer-scale) where Titanium particles of a Titanium particle structured porous transport layer are not coated with a catalyst layer.

FIG. 6 depicts an example of an improved porous transport layer composition at an atomic scale (nanometer-scale) where Titanium particles are coated with a percolated coating composition.

FIG. 7 depicts the improved porous transport layer composition in another embodiment where the porous transport layer composition is assembled with a catalyst coated membrane in a proton exchange membrane water electrolysis cell.

FIG. 8 depicts an image showing the improved porous transport layer composition with significantly increased catalyst utilization and catalyst area-specific activity.

FIG. 9 depicts a flow chart describing the method of infiltrating/impregnating a catalyst layer onto a porous transport layer composition for an electrochemical cell via infiltration/impregnation.

FIG. 10 depicts a flow chart describing a method of impregnating a catalyst layer onto a porous transport layer composition for an electrochemical cell via electrophoretic deposition.

FIG. 11 depicts a flow chart describing a method of impregnating a catalyst layer onto a porous transport layer composition for an electrochemical cell via electroplating.

### DETAILED DESCRIPTION

The following disclosure provides improved porous transport layer (PTL) compositions and their methods of making. More specifically, the following disclosure relates to PTL compositions and methods of coating catalyst layers onto PTL compositions.

These PTL compositions advantageously improve catalyst utilization and area-specific catalyst activity to achieve improved catalytic activity with a smaller amount of catalyst. As used herein, “area-specific catalyst activity” may refer to the catalytic activity of catalyst materials per unit area of the cell.

Thus, improvement to the area-specific catalytic activity may reduce cost, increase sustainability by using fewer resources required for production, improve the performance of the catalyst and electrochemical cell/stack, and enhance safety by reducing the risk of safety hazards associated with the handling and use of the catalyst, such as fire or explosion.

### Definitions

As used herein, a PTL made up of “titanium particles” may refer to a structure created by sintering together titanium (Ti) particles under high heat and pressure to form a porous, electrically conductive structure. This structure allows the reactant gases, such as hydrogen and oxygen, to flow through the PTL and reach the catalyst layer where the electrochemical reactions take place.

As used herein, a PTL made up of “titanium fibers” may refer to a structure created by weaving or braiding titanium (Ti) fibers together to form a sheet or mat. The mat is then treated with a binder, (e.g., a polymer), to hold the fibers together. This mat is then sintered at high temperature and pressure to form a solid, porous Ti PTL.

As used herein, “infiltration/impregnation” may refer to a process used to introduce a desired material into the pores or interstices of a substrate, typically a solid material. The process may include introducing the material in liquid form into the pores of the substrate, followed by curing or solidification of the material to form a solid composite.

As used herein, “electrophoretic deposition” may refer to a process used to deposit charged particles or colloids onto a conductive substrate. In electrophoretic deposition “EPD,” an electric field may be applied between a charged suspension (the colloidal particles) and a conductive substrate. The charged particles may be attracted to the oppositely charged substrate, and under the influence of the electric field, the charged particles may migrate towards and deposit onto the substrate. The deposition process may continue until a desired thickness or coating density is achieved.

As used herein, “electroplating” may refer to a process of depositing a thin layer of metal onto a substrate by electrolysis. The substrate may be a metal or a conductive material, and the metal to be deposited may be selected from a wide range of metals and alloys.

### Electrochemical Cells

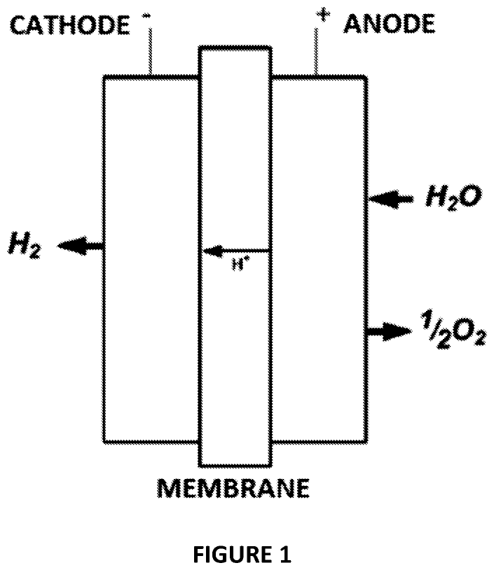

FIG. 1 depicts an example of an electrochemical or electrolytic cell for hydrogen gas and oxygen gas production through the splitting of water. The electrolytic cell includes a cathode, an anode, and a membrane positioned between the cathode and anode. The membrane may be a proton exchange membrane (PEM). PEM electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e⁻ and the cathode reaction is 2H⁺+2e⁻→H₂. The water electrolysis reaction has recently assumed great importance and renewed attention as a potential foundation for a decarbonized “hydrogen economy.”

Since the performance of a single electrolytic cell may not be adequate for many use cases, multiple cells may be placed together to form a “stack” of cells, which may be referred to as an electrolyzer stack, electrolytic stack, electrochemical stack, or simply just a stack. In certain examples, a stack may contain 50-1000 cells, 50-100 cells, 500-700 cells, or more than 1000 cells. Any number of cells may make up an electrochemical stack.

The electrochemical cells within the electrochemical stack may be configured to operate with 200 mV or less of pure resistive loss when operating at a high current density (e.g., at least 3 Amp/cm² at least 4 Amps/cm², at least 5 Amps/cm², at least 6 Amps/cm², at least 7 Amps/cm², at least 8 Amps/cm², at least 9 Amps/cm², at least 10 Amps/cm², or at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-30 Amps/cm², in a range of 3-20 Amps/cm², in a range of 3-15 Amps/cm², in a range of 3-10 Amps/cm², or in a range of 10-20 Amps/cm²).

Further, the electrochemical cells within the electrochemical stack may be used in the formation of a large-scale electrochemical plant that may be configured to generate at least 1 megawatt (MW) of power, at least 5 MW, at least 10 MW, at least 25 MW, at least 50 MW, at least 75 MW, at least 100 MW, in a range of 1-100 MW, in a range of 10-100 MW, in a range of 25-100 MW, or in a range of 50-100 MW of power.

In additional examples, the amount of water (e.g., deionized (DI) water) transferred to or circulated through each cell of the stack may be in a range of 0.25-1 mL/Amp/cell/min, in a range of 0.25-5 mL/Amp/cell/min, or in a range of 0.5-1 mL/Amp/cell/min.

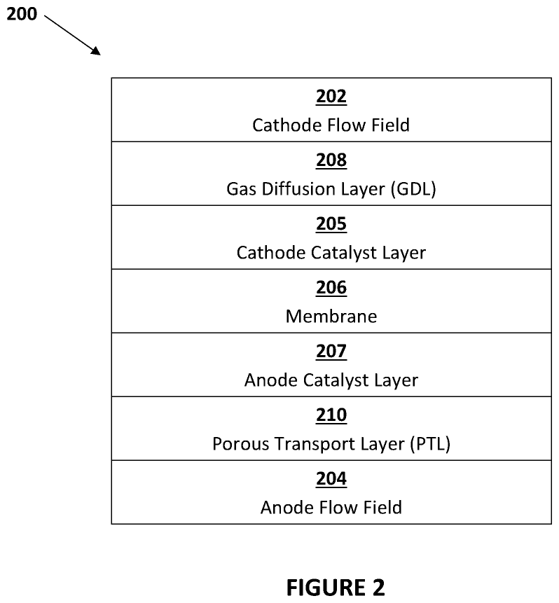

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. Alternatively, the membrane 206 may not include a cathode catalyst layer and/or an anode catalyst layer. Instead, in certain examples, a catalyst layer or catalyst composition may be affixed or adhered to a surface of an adjacent layer of the cell, such as a porous transport layer (PTL) or gas diffusion layer (GDL) as described herein.

In certain examples, additional layers may be present within the electrochemical cell 200. For example, one or more additional layers 208 may be positioned between the cathode flow field 202 and membrane 206. In certain examples, this may include a gas diffusion layer (GDL) 208 positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

In certain examples, the GDL is made from a carbon paper or woven carbon fabrics. The GDL is configured to allow the flow of hydrogen gas to pass through it. The thickness of the GDL may be within a range of 100-1000 microns, for example. As used herein, a “thickness” by which a film is characterized refers to the distance, or median measured distance, between the top and bottom faces of a film in a direction perpendicular to the plane of the film layer. As used herein, the top and bottom faces of a film refer to the sides of the film extending in a parallel direction of the plane of the film having the largest surface area.

The thickness may affect the mass transport within the cell as well as the durability/deformability and electrical/thermal conductivity of the GDL. In other words, a thinner GDL may provide better mass transport, lower resistance, and a reduction in durability (e.g., greater chance for localized deformation).

Similarly, one or more additional layers 210 may be present in the electrochemical cell between the membrane 206 and the anode flow field 204. In certain examples, this may include a porous transport layer (PTL) positioned between the membrane 206 and the anode flow field 204.

With regard to the PTL structure or material, in some examples, the PTL is made from a titanium (Ti) mesh/felt or Ti (e.g., sintered) particle structure.

As used herein, a Ti mesh/felt may refer to a structure created from microporous Ti fibers. The Ti felt structure may be sintered together by fusing some of the fibers together. Ti felt may be made by a special laying process and a special ultra-high temperature vacuum sintering process. The Ti felt may have an excellent three-dimensional network, porous structure, high porosity, large surface area, uniform pore size distribution, special pressure, and corrosion resistance, and may be rolled and processed.

In certain examples, wherein the PTL structure includes a Ti particle structure, the particle structure may refer to micrometer-sized powder particles (e.g., particles having a diameter in a range of 0.1-1000 micrometers, 1-500 micrometers, 5-100 micrometers, or 10-50 micrometers). In some examples, the particle structure includes particles having varying sizes in the micrometer-sized range. The varying sized particles advantageously allow for a more compact, higher contact resistance, less porous (<50%), smoother layer (in comparison to the titanium felt). Such a smooth layer may be positioned adjacent to the thin membrane of the cell, which, when compressed, will not subject the membrane to perforation or other types of damage like a titanium wire in a titanium felt layer may do.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the membrane. Further, gaseous byproduct oxygen is configured to be removed from the PTL to the flow fields. In such an arrangement, liquid water functions as both reactant and coolant on the anode side of the cell.

The thickness of the PTL may be within a range of 10-1000 microns, 10-500 microns, 10-100 microns, 50-1000 microns, 50-500 microns, 50-100 microns, 100-500 microns, or 100-1000 microns, for example. The thickness may affect the mass transport within the cell as well as the durability/deformability and electrical/thermal conductivity of the PTL. In other words, a thinner PTL may provide better mass transport and a reduction in durability (e.g., greater chance for localized deformation).

In some examples, an anode catalyst coating layer may be positioned between the anode flow field 204 and the PTL.

The cathode flow field 202 and anode flow field 204 of the cell may individually include a flow field plate composed of metal, carbon, or a composite material having a set of channels machined, stamped, or etched into the plate to allow fluids to flow inward toward the membrane or out of the cell.

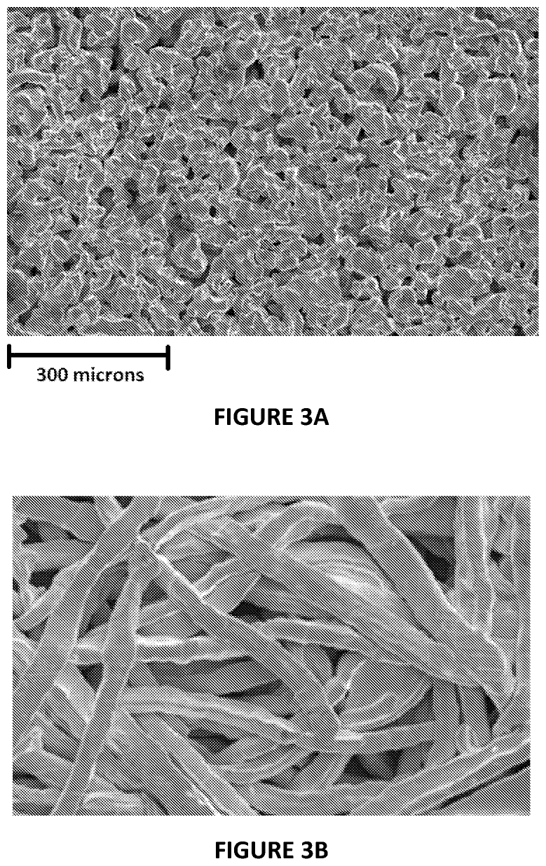

FIGS. 3a and 3b depict the surface morphology of two types of PTL structures mentioned above (i.e., a Ti particle structure and a Ti fiber structure). FIG. 3a is a scanning electron microscope (SEM) image of the surface of a PTL made with a structure of Ti particles. FIG. 3b is a SEM image of the surface of a PTL made with a structure of Ti fibers.

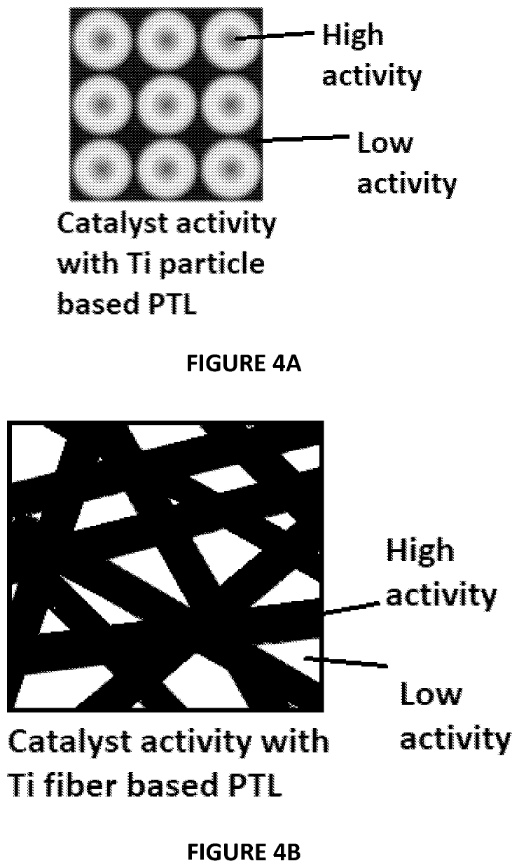

FIGS. 4a and 4b depict images showing the area-specific catalyst activity of conventional PEMWE cells having PTLs with a Ti particle structure or Ti fiber structure. FIG. 4a depicts an image showing the area-specific catalyst activity of a conventional PEMWE cell when having a PTL with Ti particle structure. FIG. 4b depicts an image showing the area-specific catalyst activity of a conventional PEMWE cell when having a PTL with Ti fiber structure.

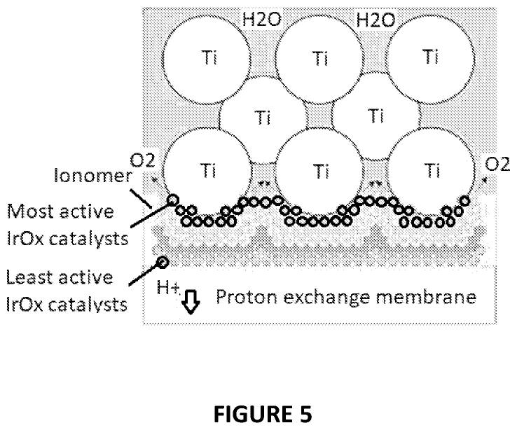

FIG. 5 depicts a conventional PEMWE cell at a nanometer-scale wherein Ti particles of a Ti particle structured PTL are not coated with a catalyst layer, but instead a catalyst layer is coated on the surface of the proton exchange membrane. As depicted in FIG. 5, the specific-area catalyst activity is the highest at the interface between the catalyst layer and the Ti particles. However, as can be seen in FIG. 5, catalyst material is not fully utilized across the area of a conventional PEMWE cell, as area-specific catalyst activity is dependent on the surface morphology of the PTL.

### Methods of Applying an Anode Catalyst Layer

Conventionally, anode catalyst layers for proton exchange membrane water electrolysis (PEMWE) cells are applied by two approaches: a catalyst coated membrane (CCM) approach; and a porous transport electrode (PTE) approach.

The CCM approach involves coating a proton exchange membrane (PEM) with a thin layer of electrocatalyst material, e.g., iridium or iridium oxide nanoparticles. The PEM may be made of a perfluorinated sulfonic acid polymer, which provides proton conductivity and separates the anode and cathode sides of the electrolyzer. In the CCM approach, the PEM may be coated by a catalyst layer either by directly coating a catalyst ink onto the membrane, or by using a decal method to transfer the catalyst coating onto the membrane.

The CCM approach offers several advantages over conventional electrode designs, including reduced ohmic and mass transport losses, improved durability and stability, and greater design flexibility. However, challenges still exist in achieving high catalyst utilization, minimizing catalyst degradation, and optimizing the performance and cost-effectiveness of the CCM approach. For instance, for the CCM approach, while the contact between membrane and catalyst is smooth and uniform, the contact between the catalyst layer and the PTL is not uniform but discrete due to the nature of PTL, which is porous even on the surface.

The PTE approach involves using a porous structure as the electrode material, which allows for efficient transport of reactants, products, and electrolytes between the electrode and the electrolyte. In an electrochemical cell, the PTL (a Ti particle structure or a Ti fiber structure) is coated using a catalyst ink to provide a porous transport electrode having a catalyst coated surface. The PTE is then assembled with a membrane to make contact between the membrane and the catalyst layer.

The PTE approach offers several advantages over conventional electrode designs, including improved mass and charge transport, reduced ohmic losses, and increased durability and stability. However, challenges still exist in optimizing the performance and cost-effectiveness of the PTE approach, particularly in achieving high catalyst utilization and minimizing catalyst degradation.

### Adding a Catalyst Coating Layer onto a Porous Transport Layer Composition

As disclosed herein, the porous transport layer may include a base composition having one or more layers (e.g., a plurality of layers) of particles or fibers. In certain examples, the base composition of the PTL includes Ti particles or fibers.

The base composition of the PTL may be coated with a catalyst coating composition to provide an improved PTL. Specifically, in certain examples, a certain thickness or depth of the base composition (e.g., the Ti particles or fibers) of the PTL may be impregnated or coated with a catalyst.

In certain examples, the catalyst coating composition includes a catalyst and an ionomer mixture. The ionomer may be advantageous in assisting in binding the catalyst with a surface of the base composition (e.g., the titanium fibers or particles.)

In certain examples, the catalyst-ionomer mixture may be coated onto Titanium (Ti) particles or fibers by various deposition methods such as impregnation/infiltration, electrophoretic deposition, and electroplating. By coating Ti particles/fibers to a certain depth from the surface of a PTL with a catalyst-ionomer mixture, issues associated with catalyst deposition onto the membrane, such as blockage of pores in the PTL and limited mass transport through the PTL, may advantageously be avoided.

Furthermore, the percolation of the catalyst coating composition onto PTL particles/fibers provides a significant extension of the electrochemical reaction sites into the 3-dimensional depth of the PTL, in contrast to a conventional 2-dimensional catalyst layer, therefore advantageously significantly increasing the catalyst utilization and catalyst area-specific activity. As a result, extremely low catalyst loading on the anode side of the PEMWE cell without sacrificing cell performance and durability is provided.

Still further, the percolation of the catalyst coating composition onto PTL particles/fibers creates an improved interface between a PEM and PTL of a PEMWE cell, thus leading to improved electrochemical activity and lower mass transport losses in the cell. Improved interfaces, lower ohmic losses, improved reaction kinetics, lower mass transport, greater durability, and higher performance of the cell may be achieved by impregnating a catalyst layer a certain depth into the PTL.

A percolated coating layer near the surface of a PTL may be a useful alternative to conventional techniques because a membrane may be more difficult to process as the membrane becomes thinner. For example, the application of a conventional catalyst layer onto a membrane may introduce rips, tears, and local thinning of the membrane, causing defects in the cell. Hence, scaling up the process of manufacturing catalyst coated membranes without defects may be difficult.

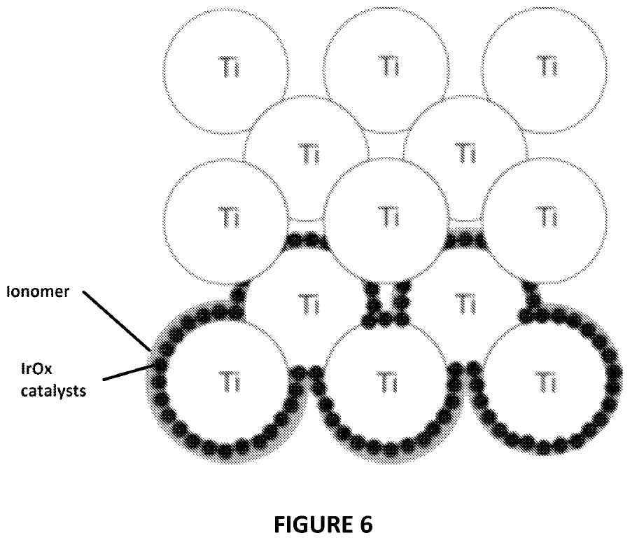

FIG. 6 depicts an example of an improved PTL composition at nanometer-scale wherein Ti particles are coated with a catalyst coating composition (e.g., a catalyst-ionomer composition). The PTL composition includes a base composition (i.e., Ti particles or fibers arranged in a plurality of layers). In the example depicted in FIG. 6, the Ti structure is made up of a plurality of layers of Ti particles.

The improved PTL in FIG. 6 further includes the catalyst coating layer (e.g., a catalyst-ionomer coating layer). The catalyst layer is provided to coat either the Ti particles or Ti fibers of the metal composition layer to a certain depth of the overall PTL. The catalyst layer may be a catalyst-ionomer mixture or catalyst-ionomer solution that is configured to penetrate one or more layers of the (e.g., Ti) base composition of the PTL by being deposited at or near a surface of the base composition. The catalyst-ionomer mixture/solution may be deposited via an infiltration/impregnation method, an electrophoretic deposition method, or an electroplating method, which are further described below.

The catalyst-ionomer mixture/solution may include a metal catalyst and an ionomer. The metal catalyst may include a metal such as iridium or a metal oxide such as iridium oxide, iridium oxyhydroxide, and the like. In the example depicted in FIG. 6, the catalyst is iridium oxide.

Additionally, the ionomer of the catalyst-ionomer mixture may be any commercially available ionomer within the electrochemical field, such as perfluorinated ionomers. Non-limiting examples include ionomers such as sulfonated tetrafluoroethylene based fluoropolymer-copolymers (e.g., Nafion™), tetrafluoroethylene and sulfonyl fluoride vinyl ester-based copolymers (e.g., Aquivion®), Flemion™, and the like.

In certain examples, the thickness of the catalyst coating itself on the particles or fibers of the base composition of the PTL is configurable. In certain examples, the thickness of the catalyst coating on the particles or fibers is at least 0.01 micron, at least 0.1 micron, at least 1 microns, at least 2 microns, at least 3 microns, at least 4 microns, at least 5 microns thick. In other examples, the catalyst coating composition may be configured to coat the base composition of the PTL to a depth in a range of 0.01-5 microns, 0.01-1 micron, 0.1-5 microns, 0.1-1 micron, or 1-5 microns.

Furthermore, as mentioned above, to improve and extend the electrochemical reaction sites into the 3-dimensional depth of the PTL composition, the catalyst coating composition may be configured to coat the Ti particles at a certain depth into the base composition of the PTL structure. In certain examples, the catalyst coating composition may be configured to percolate into and coat at least 5%, at least 10%, at least 15%, at least 20%, at least 25%, at least 30%, at least 35%, at least 40%, at least 45%, or at least 50% of the depth or thickness of the overall PTL. In other examples, the catalyst coating composition may be configured to percolate into and coat 5-50%, 10-40%, or 20-30% of the depth or thickness of the overall PTL.

In yet other examples, the catalyst coating composition may be configured to coat the base composition of the PTL to a depth of at least 1 micron, at least 5 microns, at least 10 microns, at least 15 microns, at least 20 microns, at least 25 microns, at least 30 microns, at least 35 microns, at least 40 microns, at least 45 microns, or at least 50 microns. In other examples, the catalyst coating composition may be configured to coat the base composition of the PTL to a depth in a range of 1-50 microns, 1-25 microns, 5-50 microns, 5-25 microns, 10-50 microns, 10-25 microns, or 25-50 microns.

For example, a base composition having metal particles with Ti particle diameter sizes of 5 microns may have the percolated catalyst coating composition at a depth of at least 5 microns or at least 10 microns to coat at least one layer or at least two layers of the plurality of layers of the base composition of the PTL. However, a PTL composition having a metal composition layer with Ti particle diameter sizes of 25 microns may be configured to have a catalyst coating composition at a depth of at least 25 microns or at least 50 microns. Thus, it may be desirable to adjust the depth of the catalyst coating composition into the base composition of the PTL depending on the diameter size of the (e.g., Ti) particles of the base composition to appropriately coat at least one or at least two layers of the particles of the base composition.

Furthermore, in another embodiment, the PTL composition may have a base composition layer having a (e.g., Ti) fiber structure. A PTL composition, having a metal composition layer with Ti fiber diameter sizes of at least 20 microns, may be configured to a catalyst coating at a depth of at least 20 microns or at least 40 microns to coat at least one layer or at least two layers of the plurality of layers of the base composition of the PTL. However, a PTL composition, having a metal composition layer with Ti fiber diameter sizes of 30 microns, may have a catalyst coating at a depth of at least 30 microns or at least 60 microns. Thus, it may be desirable to adjust the depth of the catalyst coating composition into the base composition of the PTL depending on the diameter size of the (e.g., Ti) fibers of the base composition to appropriately coat at least one or at least two layers of the fibers of the base composition.

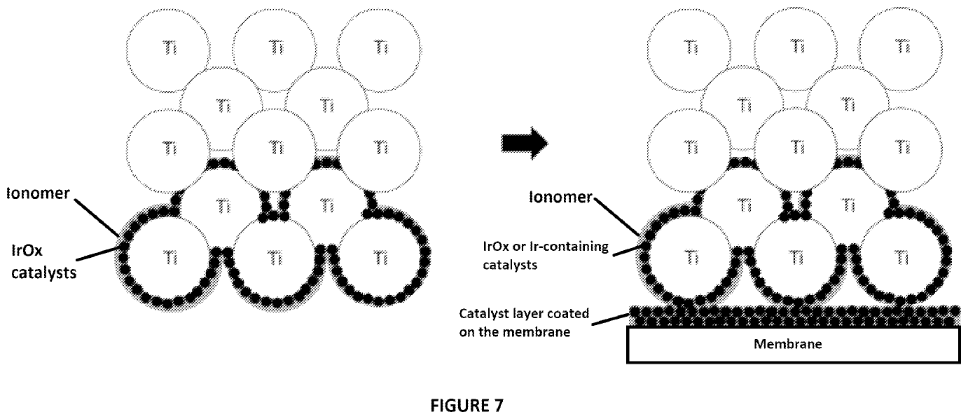

FIG. 7 depicts the improved PTL composition in another embodiment where the PTL composition is assembled with a CCM in a PEMWE cell. The PTL composition may be assembled with a CCM to improve both the interface between a catalyst layer and a membrane and the interface between the PTL composition and the catalyst.

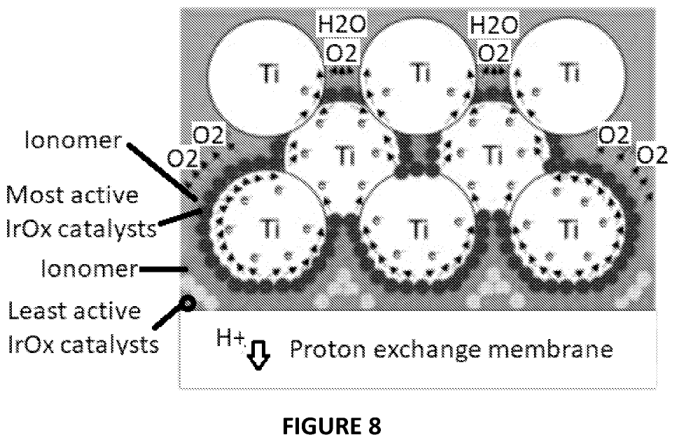

The improved configurations disclosed in FIGS. 6 and 7 herein significantly extend the electrochemical reaction sites into the 3-dimensional depth of the PTL composition, in contrast to a conventional 2-dimensional PTL or catalyst layer. Thus, the improved PTL composition significantly increases the catalyst utilization and catalyst area-specific activity. For instance, FIG. 8 depicts a graph showing the improved PTL composition with significantly increased catalyst utilization and catalyst area-specific activity.

### Methods of Coating Porous Transport Layer Compositions with Catalysts

As mentioned above, various methods may be used to coat particles or fibers of a PTL composition with a catalyst coating composition. For example, a catalyst coating composition may be deposited onto the particles or fibers of the base composition of the PTL via infiltration/impregnation, electrophoretic deposition, or electroplating.

### Infiltration/Impregnation

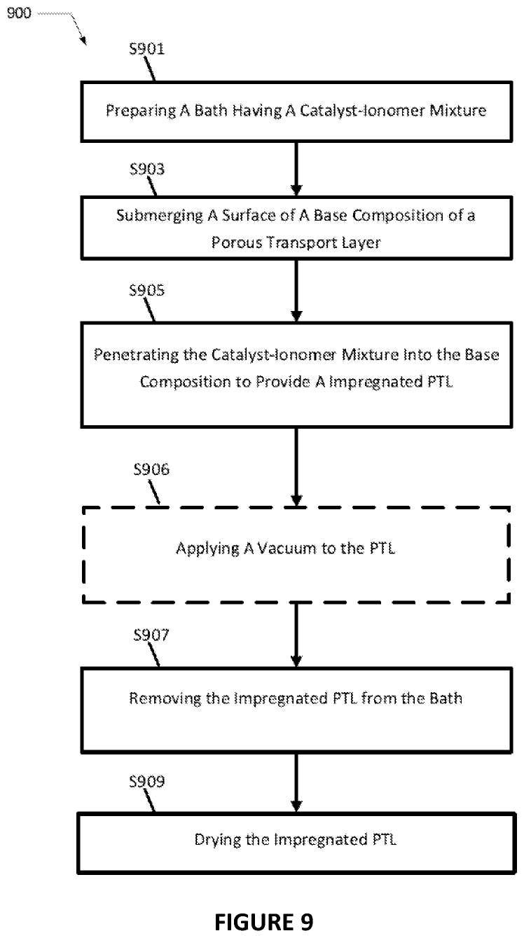

In one exemplary method, a thin layer of catalyst-ionomer mixture can be applied onto the surface of Ti particles or Ti fibers as part of a PTL by infiltration/impregnation. FIG. 9 depicts a flow chart 900 describing the method of coating a catalyst composition onto the fibers or particles of the PTL via infiltration/impregnation.

In act S901, a bath is prepared. The bath includes a catalyst-ionomer mixture having a catalyst, an ionomer, and a solvent (i.e., a catalyst ink). The catalyst in the catalyst-ionomer mixture may be any metal or metal oxide catalyst such as iridium, iridium oxide, iridium oxyhydroxide, or the like. The ionomer in the catalyst-ionomer mixture may be any ionomer such as described above, e.g., Nafion™, Aquivion®, Flemion™, or the like. Additionally, any solvent may be used, such as water, isopropyl alcohol, or the like.

In act S903, a surface of a base composition of the PTL composition is submerged a certain depth into the bath of the catalyst-ionomer mixture. The base composition of the PTL has a structure made of titanium particles or fibers. Additionally, the submerged surface of the base composition of the PTL may be the surface configured to be positioned adjacent to the PEM of an electrochemical cell.

The depth that the base composition may be submerged into the bath may be configurable based on the desired depth of catalyst coating of particles or fibers of the base composition of the PTL. This may depend on the overall thickness of the PTL and/or the diameter sizes of the (e.g., titanium) particles or fibers, as described above.

In act S905, the catalyst-ionomer mixture penetrates, by capillary force, into the base composition of the PTL such as to provide impregnated or catalyst coated base composition.

Alternatively, in act S906, a vacuum may be applied to a vacuum chamber that encloses the bath containing the impregnated or catalyst coated PTL. The vacuum applied to the chamber enclosing the bath containing the impregnated metal composition layer may be mild. The vacuum advantageously may enhance the capillary force by removing the air from the pores, reducing the pressure in the pores, and increasing the capillary forces that cause the catalyst-ionomer mixture to be drawn into the pores of the base composition. Thus, a rate of penetration of the catalyst-ionomer mixture into the base composition may increase.

In act S907, the impregnated or catalyst coated PTL is removed from the bath having the catalyst-ionomer mixture after the catalyst-ionomer mixture has penetrated into the metal composition layer. The impregnated PTL is cleaned, and any excess catalyst-ionomer mixture on the PTL is removed.

Lastly, in act S909, the PTL is then dried to provide a catalyst coating to a desired depth of the base composition of the PTL.

As noted above, this improved PTL composition advantageously provides a significant extension of the electrochemical reaction sites into the 3-dimensional depth of the PTL composition, therefore significantly increasing the catalyst utilization and catalyst area-specific activity.

### Electrophoretic Deposition

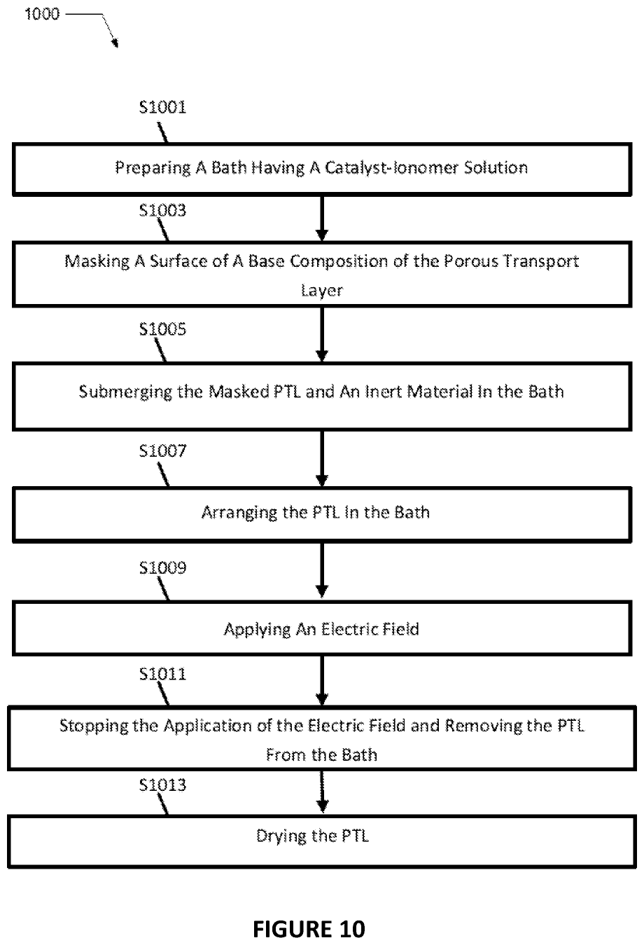

In another exemplary method, a thin layer of catalyst-ionomer mixture can be applied onto the surface of Ti particles or Ti fibers as part of a PTL by electrophoretic deposition. FIG. 10 depicts a flow chart 1000 describing a method of coating a catalyst composition onto the fibers or particles of the PTL via electrophoretic deposition.

In act S1001, a bath is prepared. The bath includes a catalyst-ionomer solution having a catalyst, an ionomer, and an electrolyte. Specifically, the catalyst may be iridium with charged ligands, and the ionomer may have the same charge as the ligands. Alternatively, the catalyst in the catalyst-ionomer mixture may be any catalyst containing a metal or metal oxide such as iridium, iridium oxide, iridium oxyhydroxide, or the like. Furthermore, the ionomer in the catalyst-ionomer mixture may be any ionomer, including those described above such as Nafion™, Aquivion®, Flemion™, or the like. Additionally, any electrolyte may be used including inorganic salts such as sodium chloride, potassium chloride, and/or magnesium nitrate, as well as organic compounds such as ammonium acetate and/or ethylene diamine.

In act S1003, a first surface of a base composition (e.g., titanium fibers or particles) of the PTL is masked, wherein the second, opposite surface of the base composition of the PTL remains exposed. The masking of one surface of the PTL is conducted to concentrate the coating of the catalyst composition on the second, exposed surface of the PTL, which is configured to be positioned adjacent to the membrane of the electrochemical cell. Masking may be done by using any number of techniques or materials such as Kapton tape or an acrylic coating.

In act S1005, the masked PTL and an inert material are submerged into the bath containing the catalyst-ionomer solution. The masked PTL is configured to function as an anode and the inert material is configured to function as a cathode for the electrophoretic deposition. In certain examples, the inert material may any known cathodic material such as copper, platinum, carbon, or the like.

In act S1007, the second surface (i.e., the exposed surface) of the base composition of the PTL is arranged to face the inert material/cathode.

In act S1009, an electric field is applied across the cathode and anode such that the iridium nanoparticles in the catalyst-ionomer solution are deposited at a certain depth into the second surface of the base composition. The depth at which the catalyst coating is targeted in this process may depend on the overall thickness of the PTL and/or the diameter sizes of the (e.g., titanium) particles or fibers, as described above.

In act S1011, the electric field across the cathode and anode is stopped and the PTL is removed from the bath.

In act S1013, the PTL is dried until the electrolyte in the catalyst-ionomer solution has evaporated to provide the catalyst coated PTL.

As noted above, this improved PTL composition advantageously provides a significant extension of the electrochemical reaction sites into the 3-dimensional depth of the PTL, therefore significantly increasing the catalyst utilization and catalyst area-specific activity.

### Electroplating

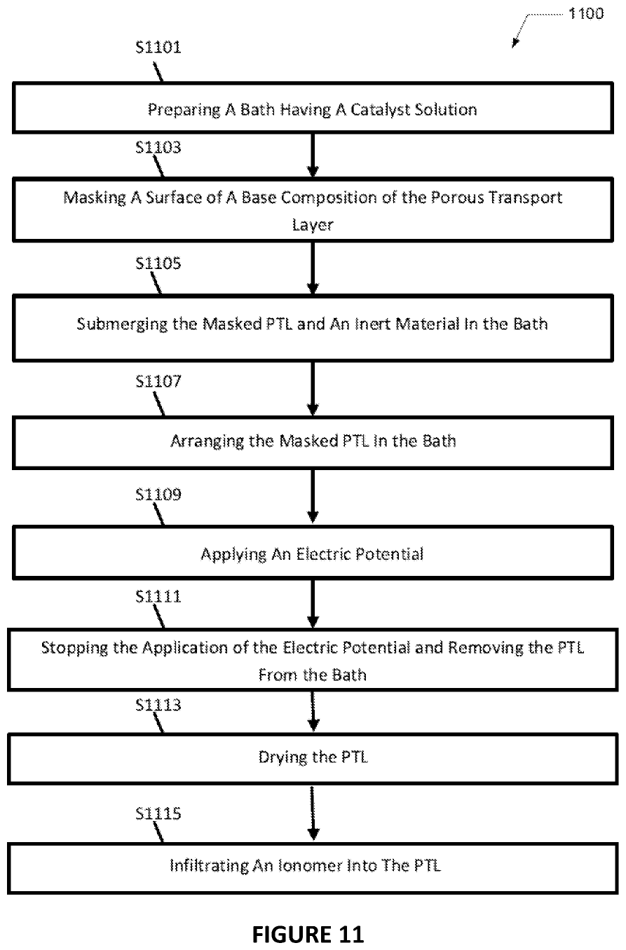

In another exemplary method, a thin layer of catalyst-ionomer mixture can be applied onto the surface of Ti particles or Ti fibers as part of a PTL composition by electroplating. FIG. 11 depicts a flow chart 1100 describing a method of coating a catalyst composition onto the fibers or particles of the PTL via electroplating.

In act S1101, a bath is prepared. The bath includes a catalyst solution having a catalyst and an electrolyte. In certain examples, the catalyst solution may include an iridium salt dissolved in an electrolyte. Additionally, any electrolyte may be used including inorganic salts such as sodium chloride, potassium chloride, and/or magnesium nitrate, as well as organic compounds such as ammonium acetate and/or ethylene diamine.

In act S1103, a first surface of a base composition (e.g., titanium fibers or particles) of the PTL is masked, wherein the second, opposite surface of the base composition of the PTL remains exposed. As noted above, the masking of one surface of the PTL is conducted to concentrate the coating of the catalyst composition on the second, exposed surface of the PTL, which is configured to be positioned adjacent to the membrane of the electrochemical cell. Masking may be done by using any number of techniques or materials such as Kapton tape or an acrylic coating.

In act S1105, the masked PTL and an inert material are submerged into the bath containing the catalyst solution. The masked PTL is configured to function as an anode, and the inert material is configured to function as a cathode for the electrophoretic deposition. In certain examples, the inert material may any known cathodic material such as copper, platinum, carbon, or the like.

In act S1107, the second surface (i.e., the exposed surface) of the base composition of the PTL is arranged to face the inert material/cathode.

In act S1109, an electric potential is applied across the cathode and anode such that the iridium nanoparticles in the catalyst solution are deposited at a certain depth into the second surface of the base composition. In other words, due to an electrochemical reaction, the iridium salt is reduced and deposited onto the base composition of the PTL composition. The depth at which the catalyst coating is targeted in this process may depend on the overall thickness of the PTL and/or the diameter sizes of the (e.g., titanium) particles or fibers, as described above.

In act S1111, the electric potential across the cathode and anode is stopped and the PTL is removed from the bath.

In act S1113, the PTL is dried until the electrolyte in the catalyst solution has evaporated to provide the catalyst coated PTL. The iridium may then oxidize depending on the desired process.

In act S1115, an ionomer is infiltrated into the catalyst coated PTL such that the ionomer is mixed with the iridium nanoparticles to provide a catalyst-ionomer coating.

As noted above, this improved PTL composition advantageously provides a significant extension of the electrochemical reaction sites into the 3-dimensional depth of the PTL, therefore significantly increasing the catalyst utilization and catalyst area-specific activity.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1-9. (canceled)

10. A method of coating a catalyst composition onto a base composition of a porous transport layer (PTL), the method comprising:
preparing a bath having a catalyst-ionomer mixture, the catalyst-ionomer mixture having a catalyst, an ionomer, and a solvent;
submerging at least a portion of the base composition of the PTL into the bath of the catalyst-ionomer mixture, the base composition having a structure made up of particles or fibers;
penetrating, by capillary force, the catalyst-ionomer mixture into the base composition of the PTL, such as to provide an impregnated composition;
removing the impregnated composition from the bath; and
drying the impregnated composition until the solvent in the catalyst-ionomer mixture has evaporated to provide a catalyst coated PTL composition in which the catalyst has coated the particles or the fibers of the base composition to a depth of the PTL.

11. The method of claim 10, further comprising:
enclosing the bath containing the impregnated composition in a vacuum chamber to apply a vacuum such that the capillary force increases a rate of penetration of the catalyst-ionomer mixture into the base composition of the PTL.

12. The method of claim 10, wherein the catalyst of the catalyst-ionomer mixture comprises a metal or a metal oxide.

13. The method of claim 10, wherein the catalyst comprises iridium or iridium oxide.

14. The method of claim 10, wherein the base composition comprises titanium fibers or titanium particles.

15. The method of claim 10, wherein the depth of the particles or the fibers coated is at least 5 microns.

16. The method of claim 10, wherein the depth of the particles or the fibers coated is at least 5% of an overall thickness of the PTL.

17. A method of coating a catalyst composition onto a base composition of a porous transport layer (PTL) via electrophoretic deposition, the method comprising:
preparing a bath having a catalyst-ionomer solution, the catalyst-ionomer solution comprising iridium (Ir) nanoparticles with charged ligands, an ionomer having a same charge as the charged ligands, and an electrolyte;
masking a first surface of the base composition of the PTL, the base composition comprising a structure made up of particles or fibers;
submerging the PTL and an inert material into the bath, wherein the masked first surface of the base composition functions as an anode and the inert material functions as a cathode for the electrophoretic deposition, and wherein an opposite, second surface of the base composition is facing the cathode;
applying an electric field across the cathode and the anode such that the iridium nanoparticles in the catalyst-ionomer solution are deposited to a depth into the second surface of the base composition of the PTL;
removing the PTL from the bath; and
drying the PTL until the electrolyte in the catalyst-ionomer solution has evaporated to provide a catalyst coated PTL.

18. The method of claim 17, wherein the electrolyte comprises of an aqueous electrolyte, an organic electrolyte, an ionic liquid, or a molten salt.

19. The method of claim 17, wherein the base composition comprises titanium fibers or titanium particles.

20. The method of claim 17, wherein the depth of the particles or the fibers coated is at least 5 microns.

21. The method of claim 17, wherein the depth of the particles or the fibers coated is at least 5% of an overall thickness of the PTL.

22. A method of coating a catalyst composition onto a base composition of a porous transport layer (PTL) via electroplating, the method comprising:
preparing a bath having a catalyst solution, the catalyst solution comprising iridium (Ir) salt and an electrolyte;
masking a surface of the base composition of the PTL, wherein the base composition comprises a structure made up of particles or fibers;
submerging the PTL and an inert material into the bath, wherein the masked surface of the base composition functions as an anode and the inert material functions as a cathode for the electroplating, and wherein a second, opposite surface of the base composition is facing the cathode;
applying an electric potential to the cathode and the anode such that iridium within the catalyst solution is deposited to a depth into the second surface of the base composition of the PTL;
removing the PTL from the bath;
drying the PTL until the electrolyte in the catalyst solution has evaporated to provide a catalyst coated PTL; and
infiltrating an ionomer into the catalyst coated PTL such that the ionomer is mixed with the iridium to provide a catalyst-ionomer coating.

23. The method of claim 22, wherein the electrolyte comprises of an aqueous electrolyte, an organic electrolyte, an ionic liquid, or molten salt.

24. The method of claim 22, wherein the base composition comprises titanium fibers or titanium particles.

25. The method of claim 22, wherein the depth of the particles or the fibers coated is at least 5 microns.

26. The method of claim 22, wherein the depth of the particles or the fibers coated is at least 5% of an overall thickness of the PTL.
